(19) United States
(12) Patent Application Publication
(10) Pub. No.: US 2011/0097591 A1
(43) Pub. Date: Apr. 28, 2011

(54) FURNITURE ARTICLE AND METHOD OF MANUFACTURE THEREOF

(75) Inventor: Wing Yiu LAM, Fotan (HK)

(73) Assignee: Sincere International Trading Co. Ltd., Fotan (HK)

(21) Appl. No.: 12/909,433

(22) Filed: Oct. 21, 2010

(30) Foreign Application Priority Data
Oct. 22, 2009 (HK) 09109828.0

(51) Int. Cl. B32B 15/10; B32B 37/00

(52) U.S. Cl. 428/464; 156/60

(57) ABSTRACT

A composite furniture article comprising a load bearing structural frame including a plurality of load bearing members, wherein the load bearing members are formed from a metal or metallic material; a non-load bearing timber cortex affixed to the periphery of at least a portion of a load bearing member of said structural frame; wherein the timber cortex is affixed to the frame and located such that said structural frame bears substantially all load applied to the furniture article and the timber cortex bears substantially no load.

### FIELD OF THE INVENTION

The present invention relates to articles of furniture, in particularly composite articles of furniture comprising metallic and wooden components.

### BACKGROUND OF THE INVENTION

Furniture articles, in the main, have typically been made from timber components which are either glued and/or dowelled together so as to form an article, such as a chair, table or the like.

Such articles of furniture, if formed from particular timber, may often be expensive and heavy due to increasing demand of such timbers and such timber being of a high density.

Metallic or plastic articles of furniture exist in the art, typically for applications such as outdoor furniture and budget-type indoor furniture. Such articles are generally not as aesthetically pleasing as traditional articles of furniture, and may be overlooked in preference to traditional timber-type furniture or used as a compromise to timber furniture.

The increasing demand on timber for manufacturing of furniture places an increasing cost upon furniture which is to be made of such material.

### OBJECT OF THE INVENTION

The present invention seeks to address or at least substantially ameliorate at least some of the deficiencies as exhibited by the prior art.

### SUMMARY OF THE INVENTION

In a first aspect, the present invention provides a composite furniture article comprising a load bearing structural frame including a plurality of load bearing members, wherein the load bearing members are formed from a metal or metallic material; and a non-load bearing timber cortex affixed to the periphery of at least a portion of a load bearing member of said structural frame. The timber cortex is affixed to the frame and located such that said structural frame bears substantially all load applied to the furniture article and the timber cortex bears substantially no load.

The timber cortex is preferably comprised of a plurality of timber cladding portions, and the timber cladding portions preferably extend substantially about the periphery of a load bearing member.

Preferably, the timber cladding portions are affixed to the load bearing member by way of an adhesive material, and the adhesive material is preferably compliant such the timber cortex is substantially insulated load applied to the load bearing member.

The timber cladding portions of the load bearing member are preferably spaced apart from timber cladding portions of other load bearing members so as to prevent engagement of adjacent timber cladding portions upon application of load to the furniture article.

The timber cladding portions of the load bearing member are abutted against an adjacent timber cladding member in a manner such that the load bearing member is encapsulated and such that the timber cladding portions collectively provide a visual representation of a unitary solid timber load bearing member.

Preferably, the load bearing members of load bearing frame have a hollow cross-section, and preferably the load bearing members are formed form aluminium or alloy thereof.

At least some of the load bearing members are joined to an adjacent load bearing member preferably by way of a weldment.

The load bearing member may be a leg member of a furniture article, and preferably the article further comprising a stopper member for ground engagement and wherein the stopper member is positioned such that reaction forces from the ground surface applied to the furniture article are transferred to the load bearing member and the timber cortex is insulated from reaction force transfer.

Alternatively, the load bearing member may be a leg member of a furniture article, and wherein the load bearing member extends beyond the timber cortex such that reaction forces from the ground surface applied to the furniture article are transferred to the load bearing member and the timber cortex is insulated from reaction force transfer.

The furniture article may be selected from the group including a chair, a stool, a table, a cupboard, a wardrobe or the like.

In a further aspect, the present invention provides a method of forming a composite furniture article, the method including the step of adhering a plurality of timber cladding portions to the periphery of one of more load bearing member of a load bearing structural frame, said including a plurality of load bearing members, wherein the load bearing members are formed from a metal or metallic material. The plurality of timber cladding portions is adhered about the periphery of the load bearing member to form a timber cortex and are located such that the timber cortex is insulated from load applied to the furniture article and the load bearing members.

A load bearing member may be a leg of the furniture article, and a stopper member for engagement and load transfer between the leg and a ground surface may be affixed to the load bearing member and spaced apart form the timber cortex such that load is transferred between the load bearing member and the ground.

Preferably, the load bearing members are formed from aluminium or aluminium tubular members.

The plurality of timber cladding portions may be adhered to the load bearing member by way of an adhesive, and the adhesive material is preferably compliant such the timber cortex is substantially insulated load applied to the load bearing member.

Preferably, the timber cladding portions are abutted against an adjacent timber cladding member in a manner such that the load bearing member is encapsulated and such that the timber cladding portions collectively provide a visual representation of a unitary solid timber load bearing member.

Subsequent timber cladding portions may be adhered to further load bearing members and are spaced apart from timber cladding portions of other load bearing members so as to prevent engagement of adjacent timber cladding portions and load transmission therebetween upon application of load to the furniture article.

The composite furniture article may be further received application of upholstery.

### BRIEF DESCRIPTION OF THE DRAWINGS

FIG. 1(a) is an exploded view depiction of an exemplary embodiment of a chair according to the present invention;

FIG. 1(b) is an assembled view of the embodiment as depicted in FIG. 1(a);

FIG. 1(c) is an exploded view of a leg of the embodiment as depicted in FIG. 1(a);

FIG. 1(d) is an enlarged view of a portion of the embodiment as depicted in FIG. 1 (a);

FIG. 1(e) is a partial schematic cross-sectional view A-A of FIG. 1(a);

FIG. 1 (f) depicts a partial schematic cross-sectional view of an alternate embodiment of a leg for a furniture article in accordance with the present invention;

FIG. 2 depicts an embodiment of a load bearing member according to the present invention partially clad by timber cladding portions in a partially assembled state;

FIG. 3 depicts load bearing member and timber cladding portions of FIG. 2 in an assembled state;

FIG. 4 depicts load bearing member and timber cladding portions of FIG. 2 in a finished state;

FIG. 5 depicts a perspective view of an embodiment of a furniture article according to the present invention including load bearing members as depicted in FIG. 4;

FIG. 6 depicts a perspective view from below of the embodiment as depicted in FIG. 5;

FIG. 7 shows the embodiment as depicted in FIG. 5 and FIG. 6 in a further assembled state;

FIG. 8 shows the embodiment of the invention as depicted in FIG. 5, FIG. 6 and FIG. 7 in an assembled state;

FIG. 9 shows a cross-sectional view of a timber veneer chair leg as exhibited by the Prior Art;

FIG. 10 (a) shows a cross-sectional view of an exemplary embodiment of a chair leg according to the present invention; and

FIG. 10 (b) shows a cross-sectional view of an exemplary embodiment of a chair leg according to the present invention.

### DETAILED DESCRIPTION OF THE PREFERRED EMBODIMENTS

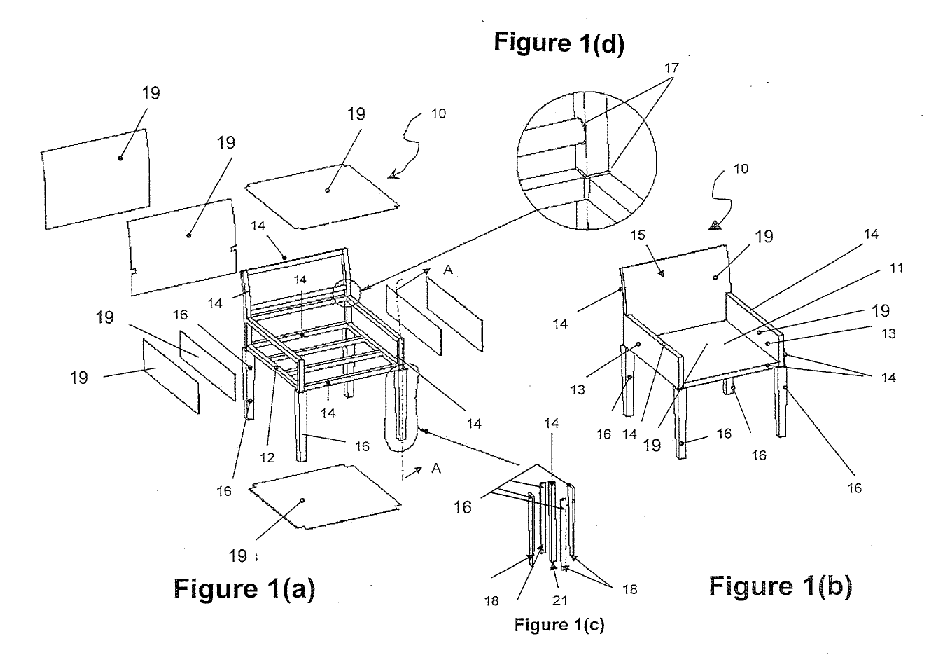

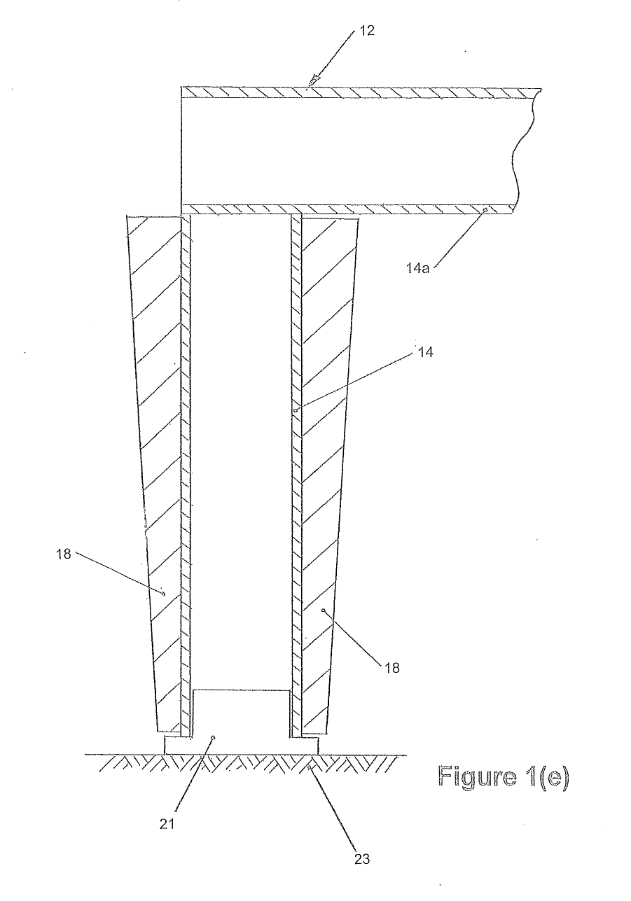

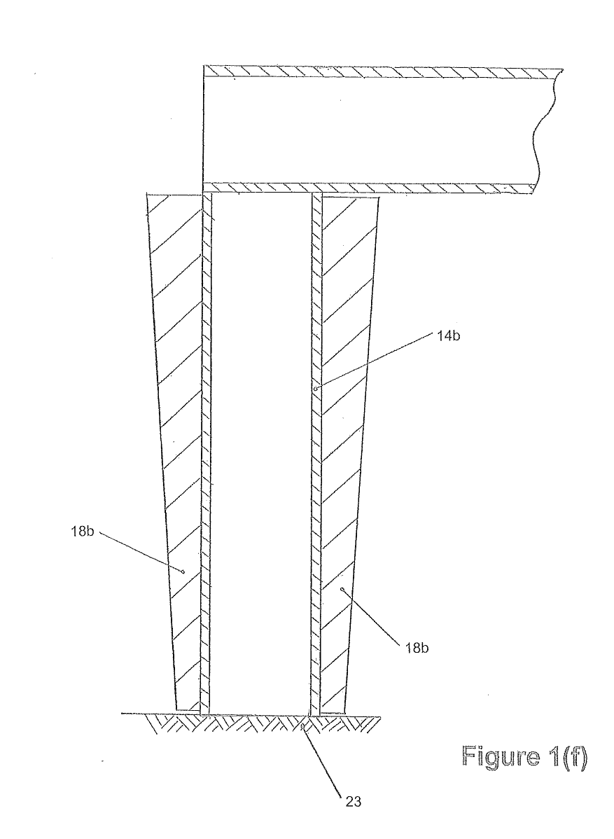

Referring to FIGS. 1(a) to (d), there is shown an exemplary embodiment of a furniture article 10 according to the present invention. In the depicted embodiment, the exemplary embodiment is that of a chair. The article comprises a load bearing structural frame 12 which is formed by a plurality of load bearing members 14, and a non-load bearing timber cortex 16 which is affixed to the periphery of load bearing members, in this embodiment those load bearing members being legs of the chairs.

In the present embodiment, the furniture article also includes a plurality of panel members 19 which are adhered to the load bearing members 14 of the structural frame 12 so as to form a base 11, arm rest 13 and a back rest 15.

The timber cortex 16 is formed from a plurality of timber cladding portions 18 which are affixed to the structural member 14 of the chair leg. In the present embodiment, the timber cladding portions 18 are affixed to the structural member 14 by way of an adhesive material such as a glue, epoxy resin or the like. The material is suitably compliant such that upon load being applied to the load bearing member 14 of the leg, substantially no load or strain is transmitted to the timber cortex 16, such that the load bearing member 14 takes all of the load when the chair is in use.

The panels 19 may also be affixed to the load bearing frame 12 by way of an adhesive or by other fixation means, however as such panel members 19 may in fact take load in some applications as load will be directly applied to the base 11, arm rest 13 and back rest 15, it is not pertinent that the panel members 19 be isolated from the load bearing structural frame 12 in the manner that the timber cortex 16 is situated.

In the present embodiment, the load bearing structural frame 12 is formed from elongate aluminium members of a square and hollow cross section. The load bearing members 14 in the present embodiment are joined together by way of weldments 17, however those skilled in the art will appreciate that other manners of a fixing the load bearing members 14 together may be used, such as by way of joining members which may be concealed within the inside of the load bearing structural frame 12.

Referring to FIG. 1(e), a partial schematic cross-sectional view of the load bearing member 14 of the chair leg is shown with the timber cladding portions18 affixed to the load bearing member 14. As shown, there is provided a stopper member 21 which is inserted within the hollow load bearing leg member 14 and which abuts with the lower portion of the load bearing member 14.

As will be noted, in the present embodiment, the timber cladding portions 18 are not engaged with the stopper member 21 such that upon application of the furniture article to the ground 23 and loading, reaction force from the ground 23 is transmitted to the load bearing member 18 to the frame 12, without any substantial load being imparted to the timber cladding portions 18.

As also shown, the upper portions of the timber cladding portions 18 do not engage with load bearing member 14a and as such, the timber cladding portions 18 do not share any of the axial load imparted to the load bearing structural frame 12 from the ground 23 reaction force.

Furthermore, the adhesive utilized in adhering the timber cladding portions 18 to the load bearing member 14 is substantially in compliant such that minimal strain from axial compression of the load bearing member 14 is transferred to the timber cladding portions 18. As such, the timber cladding portions 18 do not assist in any load bearing capacity during use of the furniture article 10.

Although the load bearing member 14 is depicted as extending beyond the cladding portions 18, those skilled in the art in alternate embodiments such as different stopper member shapes and geometries, the cladding portions 18 could extend beyond the load bearing member or be in line with the load bearing member 14, provided the stopper member 21 engaged only with the load bearing member 14 and did not contact or engage with the cladding portions in use, by way of a sufficient gap being provided between the upper face of the stopper member and the lower portions of the cladding, again without any substantial load being imparted to the timber cladding portions 18.

Referring to FIG. 1 (f), a partial schematic cross-sectional view of an alternate embodiment of load bearing member 14c suitable for a chair as described with reference to FIGS. 1(a)-(e). In this embodiment, as is shown, the load bearing member 14c is depicted as being a leg for a furniture article. In this embodiment, the load bearing member 14c extends beyond the timber cladding portions 18b so as to engage with the ground surface. Similarly, as described in reference to FIG. 1(e), the load induced from the ground reaction force is carried by the load bearing member 14c without any substantial load being imparted to the timber cladding portions 18b.

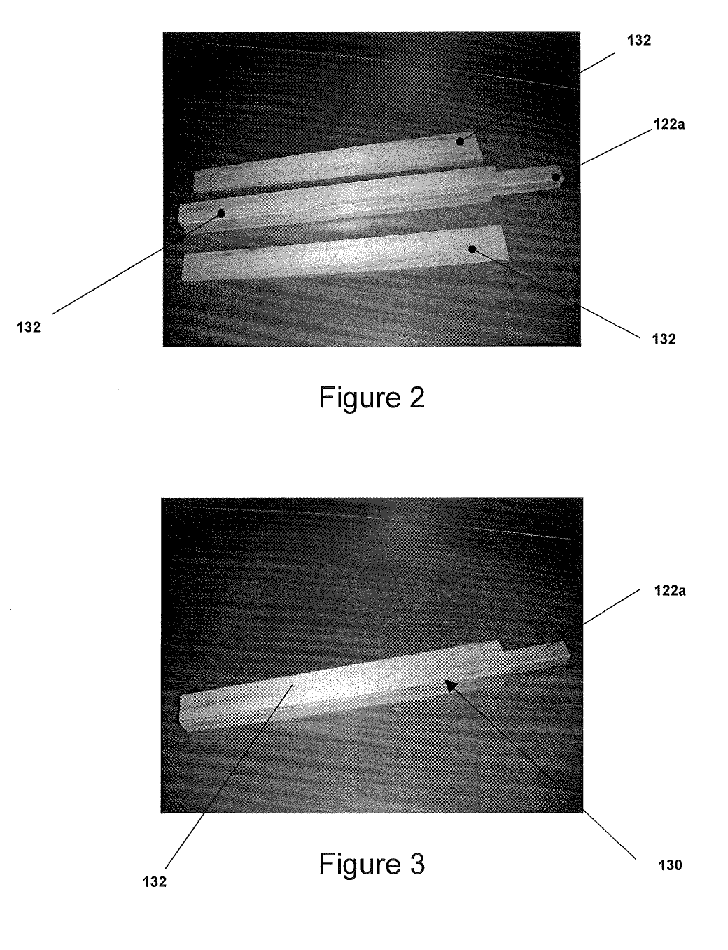

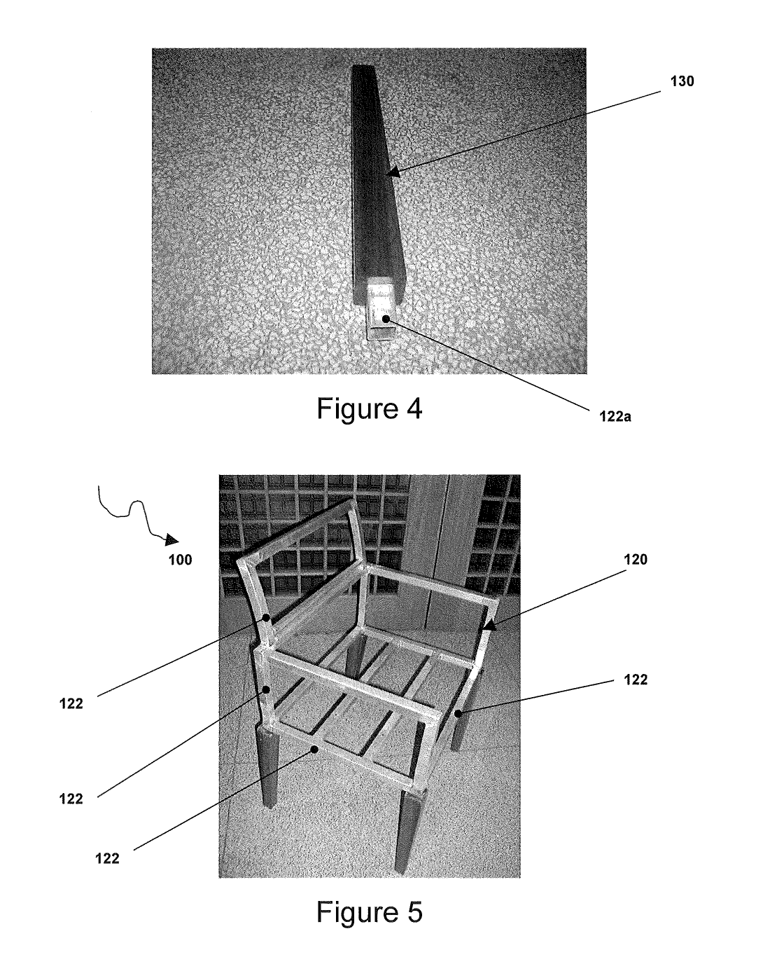

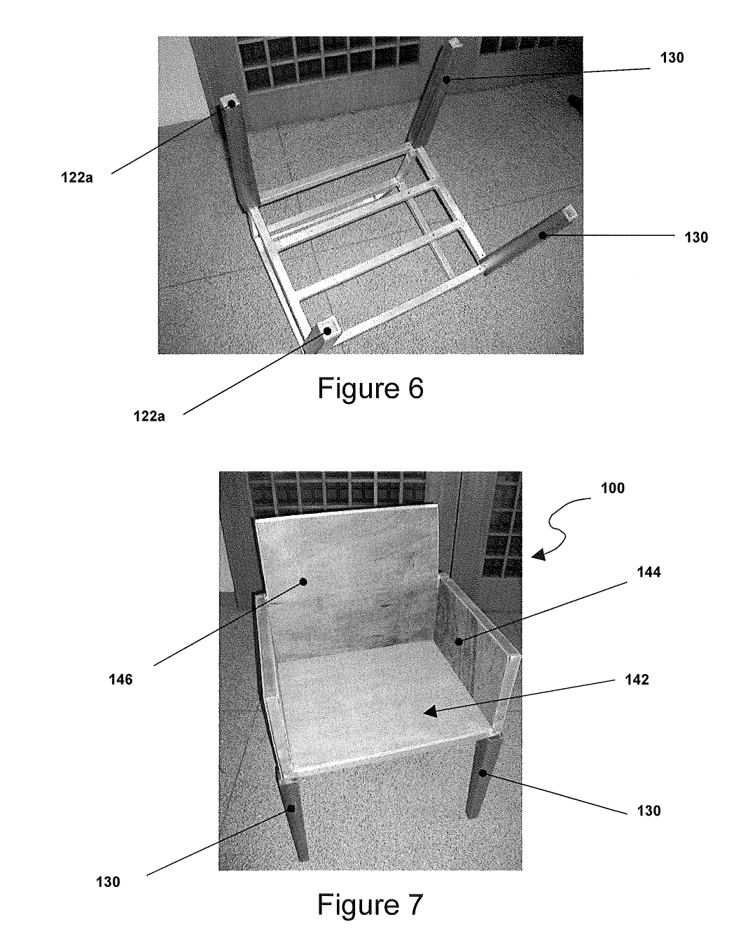

Referring to FIGS. 2-8, there is shown an exemplary embodiment of a furniture article 100 as a chair in accordance with the present invention. A load bearing structural frame 120 is comprised by a plurality of load bearing members 122 which are welded together to form the load bearing structural frame 120. In the present exemplary embodiment, there is shown the assembly process of forming the non-load bearing timber cortex 130 by a plurality of timber cladding portions 132 which are affixed to the leg load bearing member 122a by way of an adhesive. In the present embodiment, the load bearing members 122 are square in cross-section. However, those skilled in the art will appreciate that other cross-sectional geometries are equally as applicable, without departing from the scope of the invention.

The timber cladding portions 132 are pre-formed to a requisite shape so as to have a “wedge-type” geometry such that when adhered to the leg load bearing member 122, a tapered timber cortex 130 is formed. Upon suitable finishing including sanding, staining if necessary and lacquering if required, the timber cortex extending around the periphery of the leg load bearing member 122, provides a visible impression of being a solid timber leg.

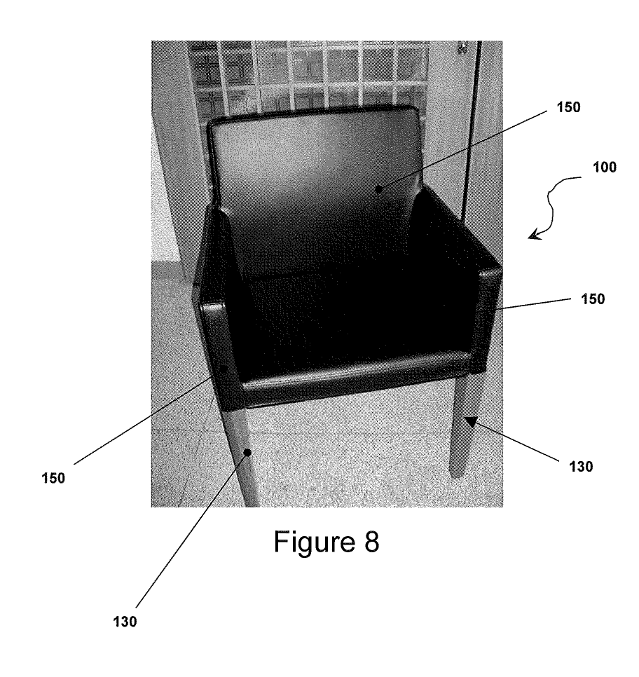

Upon affixing the timber cladding portions 132 to the leg load bearing members 122a, base member 142, arm rest members 144 and back rest member 146 may be affixed to the load bearing frame 120 in a similar manner as described with reference to FIGS. 1(a)-(c). Subsequently, upholstery 150 may be applied to the seat member 142, arm rest member 144 and back rest member 146 so as to provide a completed chair as shown in FIG. 8.

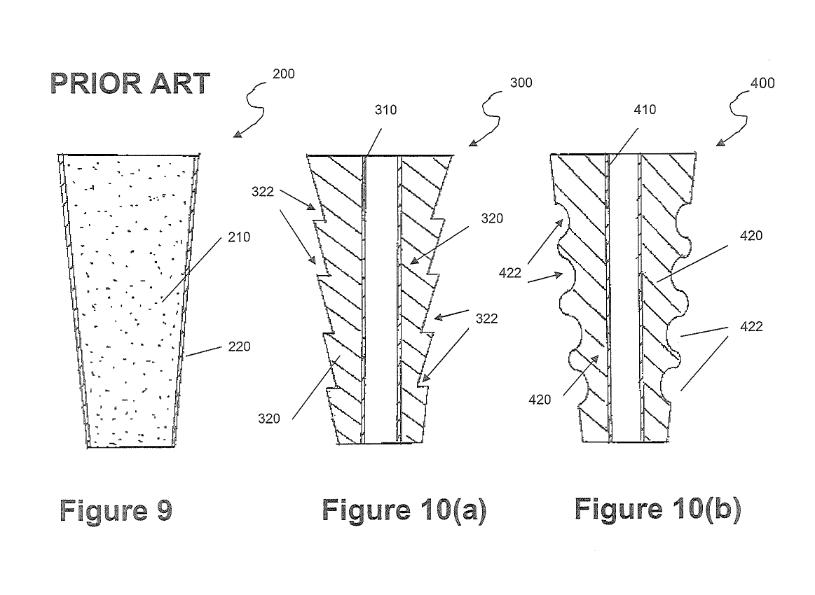

Referring to FIG. 9 and FIGS. 10(a) and (b), as shown in FIG. 9 in accordance with the prior art, there is shown an exemplary embodiment of a chair leg 200 in accordance with the prior art, which comprises a central core 210 and an outer layer of a timber venire 220. In the prior art, a relatively inexpensive core 210 may be used, which may be a wooden-particulate substance or alternatively, other less expensive timbers or other synthetic or natural occurring materials.

By comparison, as shown in FIG. 10 (a), there is shown an exemplary embodiment of a chair leg 300 in accordance with the present invention, which includes a load bearing member 310, in this embodiment a tubular aluminium central member, having a timber cortex 320 formed from a plurality of timber cladding portion in accordance with the present invention and as described above in reference to FIGS. 1-8. As shown in FIG. 10 (a), the timber cortex includes a plurality of recesses 322, which extend radially inward part way through the timber cortex 320 and toward the load bearing member 310. Such recesses 322 may be formed by way of a lathe, and by turning the leg member 300 prior to incorporation of the chair leg member 300 with the rest of an article of furniture.

As will be appreciated by those skilled in the art, the solid timber cortex, supported by the load bearing member 310, allows a significant depth of cut into the cortex 320, which allows ornate design to be imparted to the chair leg 300 in a manner such that the timber material from which the timber cortex 320 is formed provides a visual as well. as tactile sensation and impression of being a solid timber member.

Similarly, referring to FIG. 10(b), there is shown a further exemplary embodiment 400 of a chair leg having a load bearing member 410 and a timber cortex 420, in accordance with the present invention. As shown, rebates 420 are provided within the chair leg 400, by way of turning the chair leg 400 on a lathe prior to use of the chair leg in conjunction with an article of furniture.

Those skilled in the art will appreciate in comparison with FIG. 10 of the prior art, the present invention allows intricate and detailed shape geometry to be applied to the article whilst still providing a continuous outer surface of the requisite timber material from which the article is made.

Further, those skilled in the art will appreciate that a relatively thin timber venire cannot be shaped to a complex outer surface geometry as a single piece, and inherently the prior art will show discontinuity and joints within the timber at areas of change of angle or the like.

Furthermore, those skilled in the art will appreciate that any attempt to provide an ornate shape to the prior art as shown in FIG. 10(a) so as to emulate the visual characteristics of the articles of FIG. 10(a) and FIG. 10(b) will result in tooling cutting full-way through the timber venire 220 thus resulting in an article not of continuous out of service and showing the internal core material 210 from the outside of the article.

As will be appreciated and understood by those skilled in the art, the present invention allows for visual and tactile impression of a solid timber leg, whilst providing the advantages as described with reference to the present invention.

As will be appreciated by those skilled in the art, a classical type chair may be formed as a seemingly wooden-frame construct, typical as those as seen in the art, however the present invention provides a furniture article having significant advantages over existing furniture article.

Advantages as provided by the present invention include the construction of furniture articles which have less reliance on real timber materials, which provides a cost advantage in view of depleting supplies of timber, in particular classic type timbers utilized in furniture articles.

Furthermore, by use of significantly thinner timber portions to provide the timber cladding portions, off-cuts and smaller pieces of stock material may be utilized, rather than relying on thick sections to form the construct of the furniture article. Still further, by utilizing a load bearing frame formed from a metal or metal alloy, in particular, aluminium, there is not the necessity to provide a full timber frame for the construction of the articles of furniture. Furthermore, such a load bearing frame formed from an aluminium alloy provides the significant advantages of being relatively cheap, easy to assemble, increased strength, resistance to wood rot, and a decrease in weight in comparison to solid timber articles.

Thus, the present invention provides a chair which is formed so as to provide the visual characteristics of classical timber appearance whilst also providing the advantages as discussed above.

The present invention allows the use of timbers such as Hardwood, Oak, Mahogany, Beech or the like to be used, so as to provide the visual appearance, as well as appearance to touch, as being a solid timber member, in comparison to the effect derived by the use of timber veneer as utilised on the prior art.

As will be appreciated by those skilled in the art, other cross-sectional geometries of the load bearing structural frame may be used, such as circular, triangular, hexagonal or the like without departing from the scope of the invention. Furthermore, as will be appreciated by those skilled in the art, the shape of the cladding utilized may be varied depending on the visual or ornate requirement of the load bearing member of the furniture article. For example, as providing a tapered leg by wedge-shaped timber cladding portions, as described in reference to the present embodiment.

Furthermore, those skilled in the art will appreciate that in other or alternate embodiments, should the need be required, prior to fixation of the load bearing member to the furniture article, the timber cladding portions may be affixed to the load bearing member in a general shape as required, and the composite load bearing member and timber cortex may be “worked” to provide a requisite geometry, such as turning on a lathe so as to provide an ornate and desirable shape from a suitable material for post-furnishing and which also is a desired timber for the construction of furniture articles.

Again, by providing an internal load bearing member with an outer non-load bearing cortex, multiple timber cladding portions may be utilized so as to utilize timber of smaller cross-sections which normally would need to be discarded or used for other applications, thus ameliorating the necessity to utilize more expensive thick timber cross-sectional stock timber.

Furthermore, by the use of timber cladding portions, should there be a defect in the stock material, only a timber cladding member having such a defect would need to be replaced or discarded, rather than a whole stock material. As such, an ornate and visually acceptable load bearing member may be provided whilst being formed a lower cost, at a lower weight or mass, and more efficiently, whilst utilizing off-cuts of wood or timber which would normally be discarded.

In addition to the commercial advantages provided by the present invention, environmental advantages are also realized by the non-reliance on old-growth timber forests and the minimization of timber waste in the timber furniture manufacturing industry.

As will be also appreciated by those skilled in the art, although the present embodiment are depicted in the form of a chair-article, other articles of furniture having load bearing members such as rungs of chairs, stools, wardrobes, tables and the like, are equally as applicable and will be considered to also being embodiments of the present invention.

Typical adhesives suitable for use in accordance with the present invention are those including, epoxy resins, contact cements, urthethane glues, hot-melt glues or adhesive, pressure sensitive adhesives and the like. By way of example, adhesives such as Cascamite One Shot Adhesive are suitable for use in the present invention.

Furthermore, although in the present embodiments the use of adhesive to affix the timber cladding portions to the load bearing members has been described in reference to the present embodiments. Those skilled in the art will appreciate that fixation methods and devices may be equally applicable in other applications, such as internal fasteners, spurs, ridges, screws or the like, without departing from the present invention.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to a chair, it should be appreciated that the invention can apply, whether with or without modification, to other articles of furniture without loss of generality.

1. A composite furniture article comprising:
a load bearing structural frame including a plurality of load bearing members, wherein the load bearing members are formed from a metal or metallic material;
a non-load bearing timber cortex affixed to the periphery of at least a portion of a load bearing member of said structural frame;
wherein the timber cortex is affixed to the frame and located such that said structural frame bears substantially all load applied to the furniture article and the timber cortex bears substantially no load.

2. A composite furniture article according to claim 1, wherein the timber cortex is comprised of a plurality of timber cladding portions.

3. A composite furniture article according to claim 2, wherein the timber cladding portions extend substantially about the periphery of a load bearing member.

4. A composite furniture article according to claim 2, wherein the timber cladding portions are affixed to the load bearing member by way of an adhesive material.

5. A composite furniture article according to claim 4, wherein the adhesive material is compliant such the timber cortex is substantially insulated load applied to the load bearing member.

6. A composite furniture article according to claim 2, wherein the timber cladding portions of the load bearing member are spaced apart from timber cladding portions of other load bearing members so as to prevent engagement of adjacent timber cladding portions upon application of load to the furniture article.

7. A composite furniture article according to claim 2, wherein the timber cladding portions of the load bearing member are abutted against an adjacent timber cladding member in a manner such that the load bearing member is encapsulated and such that the timber cladding portions collectively provide a visual representation of a unitary solid timber load bearing member.

8. A composite furniture article according to claim 1, wherein the load bearing members of load bearing frame have a hollow cross-section.

9. A composite furniture article according to claim 1, wherein the load bearing members are formed from aluminium or an alloy thereof.

10. A composite furniture article according to claim 9, wherein at least some of the load bearing members are joined to an adjacent load bearing member by way of a weldment.

11. A composite furniture article according to claim 1, wherein the load bearing member is a leg member of a furniture article, and the article further comprising a stopper member for ground engagement and wherein the stopper member is positioned such that reaction forces from the ground surface applied to the furniture article are transferred to the load bearing member and the timber cortex is insulated from reaction force transfer.

12. A composite furniture article according to claim 1, wherein the load bearing member is a leg member of a furniture article, and wherein the load bearing member extends beyond the timber cortex such that reaction forces from the ground surface applied to the furniture article are transferred to the load bearing member and the timber cortex is insulated from reaction force transfer.

13. A composite furniture article according to claim 1, wherein the furniture article is selected from the group including a chair, a stool, a table, a cupboard, a wardrobe or the like.

14. A method of forming a composite furniture article, the method including the steps of:
(i) adhering a plurality of timber cladding portions to a periphery of at least one load bearing member of a load bearing structural frame, said load bearing structural frame including a plurality of load bearing members, wherein the load bearing members are formed from a metal or metallic material;
wherein said plurality of timber cladding portions are adhered about the periphery of the load bearing member to form a timber cortex and are located such that the timber cortex is insulated from load applied to the furniture article and the load bearing members.

15. A method accordingly to claim 14, wherein a load bearing member is a leg of the furniture article, and a stopper member for engagement and load transfer between the leg and a ground surface is affixed to the load bearing member and spaced apart from the timber cortex such that load is transferred between the load bearing member and the ground.

16. A method of forming a composite furniture article according to claim 14, wherein the load bearing members are formed from aluminium or aluminium tubular members.

17. A method of forming a composite furniture article according to claim 14, wherein the plurality of timber cladding portions are adhered to the load bearing member by way of an adhesive, and, wherein the adhesive material is compliant such that the timber cortex is substantially insulated from a load applied to the load bearing member.

18. A method of forming a composite furniture article according to claim 14, wherein the timber cladding portions are abutted against an adjacent timber cladding member in a manner such that the load bearing member is encapsulated and such that the timber cladding portions collectively provide a visual representation of a unitary solid timber load bearing member.

19. A method of forming a composite furniture article according to claim 14, wherein subsequent timber cladding portions are adhered to further load bearing members and are spaced apart from timber cladding portions of other load bearing members so as to prevent engagement of adjacent timber cladding portions and load transmission therebetween upon application of load to the furniture article.

20. A method of forming a composite furniture article according to claim 20, further comprising the step of application of upholstery to the furniture article.
